(19) United States
(12) Patent Application Publication
(10) Pub. No.: US 2007/0026940 A1
(43) Pub. Date: Feb. 1, 2007

(54) Gaming method

(76) Inventor: Frank Cannella, Northport, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/543,423

(22) Filed: Oct. 5, 2006

Related U.S. Application Data
(63) Continuation-in-part of application No. 10/436,585, filed on May 13, 2003.

(51) Int. Cl. A63F 13/00

(52) U.S. Cl. 463/28; 463/6; 463/16

(57) ABSTRACT

A gaming method is provided in which for X number of consecutive events, a subset of Y consecutive events making up an event set is determined. From said X number of consecutive events a series of overlapping consecutive event sets is prepared, each event set having Y consecutive races, wherein at least each of (Y−1) events in each event set overlaps at least one of a previous event set or a next event set. At least one separate betting pool for each event set is generated.

### CROSS REFERENCE TO RELATED APPLICATIONS

This application is a continuation in part of co-pending application Ser. No. 10/436,585 filed May 13, 2003.

### BACKGROUND

1. Technical Field

This disclosure relates to betting methods, and more particularly, to a system and method for pari-mutuel type betting based on sets of multiple consecutive overlapping events.

2. Description of the Related Art

Many games exist in the gambling arena. As with any industry, the most popular games provide the best revenue. Players are attracted to fast-paced exciting games or games with quick or instantaneous results. The most popular games usually require the least amount of commitment and/or effort by the player. For example, state lotteries provide quick picks to reduce the effort of lottery players in selecting lottery numbers.

Other games with bingo-like selections of numbers are employed for both scheduled and instant drawings. These games are particularly appealing based on their simplicity and payoff amounts, which can rise into the millions or tens of millions of dollars. Horse or dog racing provides an exciting alternative to casino gambling, but can tend to be complex since the variables, odds and handicapping techniques may be overwhelming for individuals especially novice bettors or first time bettors.

It would therefore be advantageous to provide a gaming method, which combines the excitement of, e.g., horse racing, with the potential payoffs of, e.g., state lotteries to gain the maximum amount of player draw. In addition, it would also be advantageous to provide a game having simple rules which requires minimal effort yet yields maximum excitement and high potential monetary gain to attract a greater number of players, including first time or novice players.

### SUMMARY OF THE INVENTION

A method for wagering on a plurality of outcomes where the outcomes are based on a series of events where each event includes a result having a number of items in a finishing order includes selecting picks to predict the finishing order for at least one of a series of events, comparing the picks to each item in each event to determine an accuracy of the picks, and determining a prize based upon a number of correct picks.

In other methods, the series of events may include a series of races, the number of items may include race participants, and the finishing order may include an order in which the participants finish in a race. The method may include the steps of collecting information about upcoming events, and printing a sheet or card to facilitate pick selection in accordance with the upcoming events. The step of choosing an amount to wager may also be included. The step of determining a prize based upon a number of correct picks may include determining the prize based on carry over from un-hit pools. The un-hit pools may include pools created for games with a lower number of picks and/or pools for previous events. The step of selecting picks may be performed randomly by a computer or may be performed by selecting picks as a most likely outcome based on an independent source, which determines the most likely outcome at a fixed time before the events.

The series of events may include sporting events and the number of items may include sports teams, and the finishing order may include an order in which the sports teams finish in an organization, e.g., based on wins or based on point spread.

An alternate method for wagering on a finishing order in a plurality of races includes selecting picks to predict the finishing order for at least one race, comparing the picks to an actual finishing order in each race to determine an accuracy of the picks and determining a prize based upon a number of correct picks.

A betting system and method according to one aspect of the present principles comprises a wager (e.g., a one dollar wager) in which the bettor picks the exact order of finish for a number of horses in consecutively designated overlapping race sets, with a payout to the bettor(s) with, e.g., a particular number of correct picks and/or the highest number of correct picks. Moreover, a bettor(s) who has all picks correct wins a grand ‘all-correct-picks’ pool.

A betting program may be comprised of sets of consecutively ordered thoroughbred horseraces at a single track, or as a special program of consecutively ordered races at various racetracks within or across time zones.

In one aspect, a gaming method is provided comprising the steps of determining for X number of consecutive events, a subset of Y consecutive events comprising an event set, preparing from said X number of consecutive events a series of overlapping consecutive event sets, each event set having Y consecutive races, wherein at least each of (Y−1) events in each event set overlaps at least one of a previous event set or a next event set, and generating at least one separate betting pool for each event set.

According to another aspect, a gaming method is provided comprising the steps of calculating handicaps for each race of a first race set and making selections to predict the finishing order in each race of the first set of races in a first bet, and making selections to predict a finishing order in each race of a second race set and calculating handicaps for a next consecutive race following the last race of the first race set to enter into a second bet, wherein the next consecutive race comprises a last race of a second race set.

According yet another aspect, a gaming method is provided comprising the steps of providing a first game card for listing a first set of three consecutive races and a plurality of entries for each race, providing a second game card for listing a second set of three consecutive races and a plurality of entries for each race, wherein a first race of the second set of races comprises the second race of the first set of races, handicapping each race on the first game card and indicating on the first game card a speculated order of finish for up to four entries in each race of the first set of races in a first bet, handicapping a next race following the last race of the first set and indicating on the second game card a speculated order of finish for up to four entries in each race of the second set of races in a second bet, generating at least one pool for each of said first and second bets, comparing the speculated order of finish with a determined finishing order of each race to determine a number of matching entries within each bet, and determining a prize based upon the number of matching entries.

These and other objects, features and advantages of the present invention will become apparent from the following detailed description of illustrative embodiments thereof, which is to be read in connection with the accompanying drawings.

### BRIEF DESCRIPTION OF DRAWINGS

This disclosure will present in detail the following description of preferred embodiments with reference to the following figures wherein:

FIG. 1 is a block diagram showing a gaming method in accordance with one embodiment of the present invention;

FIG. 2 shows a matrix of pools before payouts in an illustrative embodiment in accordance with the present invention;

FIG. 3 shows the matrix of pools of FIG. 2 after payouts have been determined in the illustrative embodiment in accordance with the present invention wherein lesser pools are added to increase the payouts;

FIG. 4 shows an illustrative betting card/slip for a three race bet in accordance with one embodiment of the present invention;

FIG. 5 depicts a flow diagram illustrating an exemplary gaming method overview according to an aspect of the present invention;

FIG. 6 depicts an exemplary single track race set program according to an aspect of the present invention;

FIG. 7 depicts an exemplary multiple track race set program according to an aspect of the present invention;

FIG. 8 depicts an exemplary exact pick payout distribution according to an aspect of the present invention;

FIG. 9 illustrates an exemplary betting card/slip for a 12 pick three race bet according to one embodiment of the present invention;

FIG. 10 illustrates an exemplary betting card/slip for a 12 pick four race bet according to one embodiment of the present invention;

FIG. 11 illustrates an exemplary betting card/slip for a 12 pick six race bet according to one embodiment of the present invention; and

FIG. 12 illustrates an exemplary betting card/slip for a 12 pick twelve race bet according to one embodiment of the present invention.

It should be understood that the drawings are for purposes of illustrating the concepts of the invention and are not necessarily the only possible configurations for illustrating the invention.

### DETAILED DESCRIPTION OF PREFERRED EMBODIMENTS

The present invention provides a new pari-mutuel type betting method and system, which is designed to provide a game with results based on a plurality of events.

In one embodiment the present invention provides a method for betting in horseracing, namely providing the thoroughbred horseracing industry with a product which can compete with, e.g., state lotteries and generate new fans. According to one aspect, betting sheets and/or cards are provided where a bettor can select a plurality of outcomes. The outcomes occur to provide an end result with various payoffs. The betting sheets may be distributed or purchased by the bettor or may be distributed as a promotional product.

According to another aspect, a system and method for betting is provided in which for X number of races, a number of separate bets equal to the X number of races is provided wherein each bet comprises a race set having at least Y number of consecutive races, wherein Y≧2 and wherein at least (Y−1) races in each race set overlaps at least one of a previous and a next race set. Further details will be described herein.

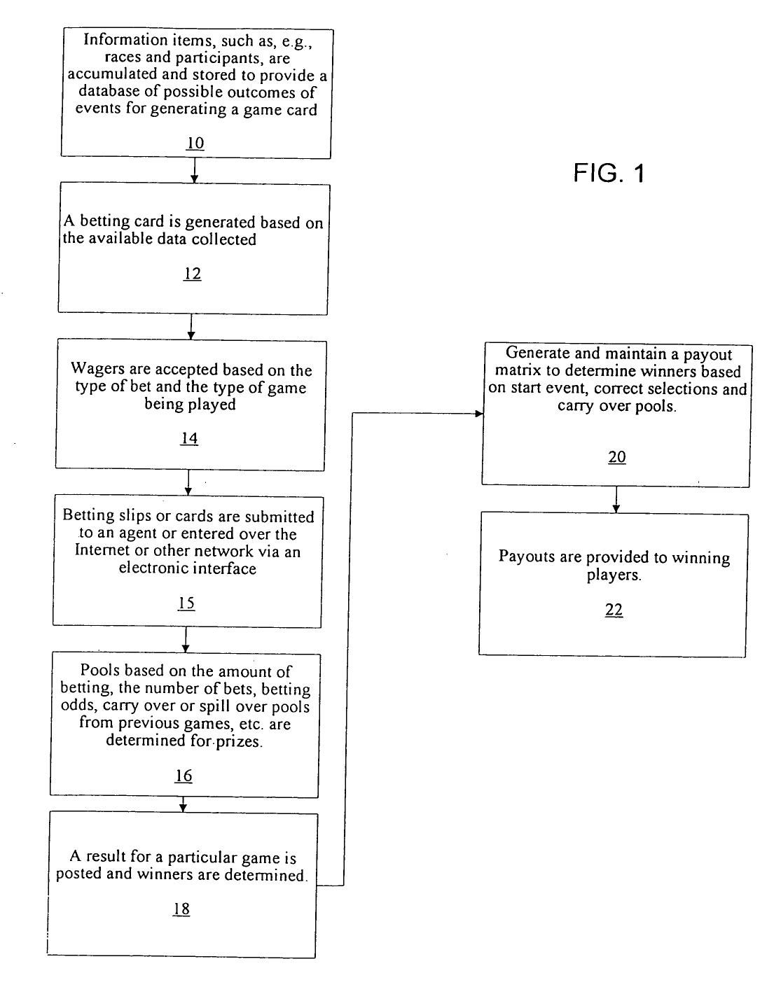

It is to be understood that the present invention may be implemented on a computer or computer network, equipped with hardware and/or software for running and maintaining a system for implementing the present invention. The blocks shown in FIG. 1 may be implemented by such forms of hardware and software.

Referring now in specific detail to the drawings in which like reference numerals identify similar or identical elements throughout the several views, and initially to FIG. 1, a flow diagram describing steps for a particularly useful embodiment will now be described with reference to horse racing. It is to be understood that the methods described herein are applicable to a plurality of different types of events. These events may include dog racing, sporting events, such as football, baseball, basketball, soccer, hockey, tennis or others, or any other events, which have a defined outcome, i.e., a winner to be decided or determined but presently unknown. The events that the present invention is particularly concerned with are preferably sequential in nature. The predicted results of the bettor are determined after a series of events have occurred and the events accumulate in favor of or to the detriment of the bettor. Preferred embodiments employ an order of finish or finish position for the event or events to determine a score for a player or bettor.

In the illustrative embodiment described with reference to FIG. 1, the system is comprised of a set of consecutively ordered events, e.g., races (preferably stakes races) which may be at the same or at various locations, such as, thoroughbred racetracks across the nation. The events may be closely timed in sequence to generate fast paced excitement as in a quick draw type game. The results of the events are preferably determined in a short amount of time. In block 10, races and participants are accumulated and stored to provide a database of possible outcomes of the events, in other words, the event participants are compiled and listed for use in the generation of game cards. This may be performed through use of a computer database or network. The information is preferably collected and stored so that it can be organized in accordance with the game of the present invention.

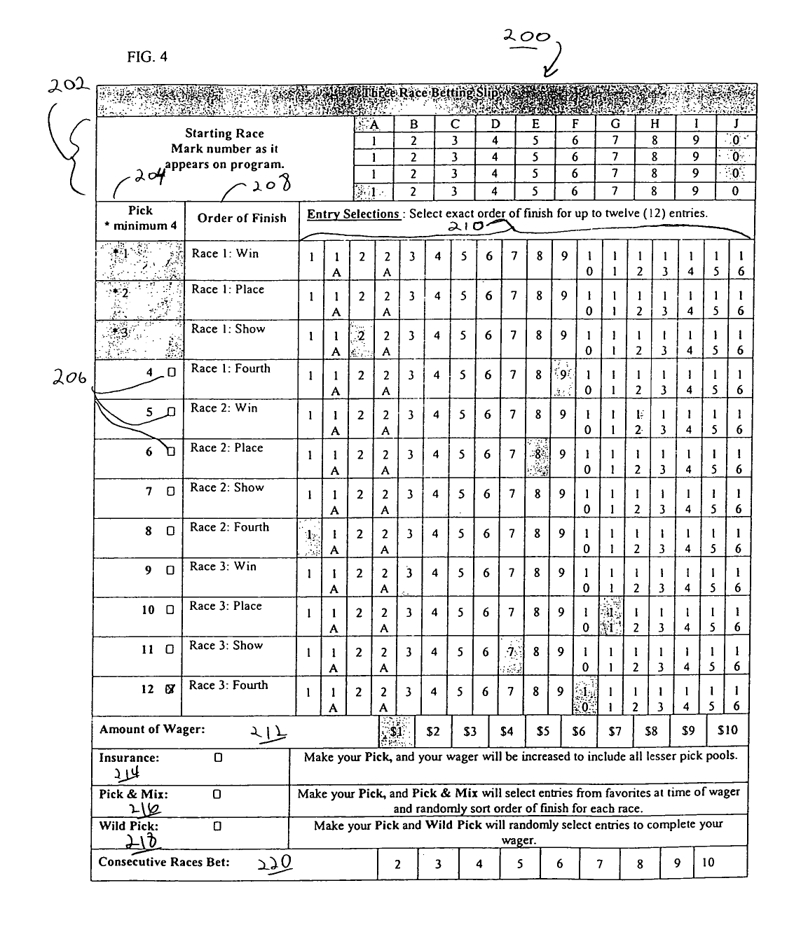

In block 12, an illustrative betting card is generated based on the available data collected in block 10. In one example, a bettor picks twelve horses, in an exact order of finish (for example, win, place, show, and fourth in three different races), in one to twelve consecutively designated races. The number of exact order finishers should be at least equal to the number of paid picks. For example, Table 1 shows an example of a bet with results (see also FIG. 4). Six correct picks were made out of 12 available selections. This will be discussed in more detail herein below.

TABLE 1

| | Race 1 | | | | Race 2 | | | | Race 3 | | | |
|---|---|---|---|---|---|---|---|---|---|---|---|---|
| | Win | Place | Show | Fourth | Win | Place | Show | Fourth | Win | Place | Show | Fourth |
| Bet | 1 | 2 | 3 | 4 | 1 | 2 | 3 | 4 | 1 | 2 | 3 | 4 |
| Results | 9 | 6 | 3 | 4 | 5 | 2 | 3 | 1 | 1 | 2 | 5 | 8 |
| Win | N | N | Y | Y | N | Y | Y | N | Y | Y | N | N |
| Correct | | | 1 | 1 | | 1 | 1 | | 1 | 1 | | |
| Picks | | | | | | | | | | | | |

Since the races are continuing, players may enter into the game at each new race. For example, a second race in a set of races could be the first race of the next set of races for new players. Therefore, in block 12, cards may be generated in real-time to accommodate the next set of races, which are about to be run. Preferably, these betting cards or programs are posted in advance of betting.

In block 14, wagers are accepted based on the type of bet and the type of game being played. In one embodiment, the bet size may be one dollar for each pick permutation (e.g., $9 for a card with 12 picks with a minimum of 4 picks, $2 for a card with 5 picks). Other embodiments are also contemplated, for example, the bet can be placed as a single fee for a whole card, for example, $1 per card. Wagers may be held in separate pools according to a number of correct picks possible in a particular set of races. For example, if the game includes 3 races, and 4 positions are included on the game card then 12 picks is the largest number of correct picks for that game. Pools may be generated for smaller numbers of correct picks from within the 12 pick pool (e.g., 4 correct picks, 5 correct picks, 6 correct picks . . . 12 correct picks) to provide additional incentives to play by increasing winning opportunities. For example, prizes for 11/12 picks or 10/12 picks and so on may be available. These smaller prizes are preferably associated with the amount of money collected as wagers for the 12 pick game.

Minimum bet may be, e.g., $1.00 per pool pick in an event set. The minimum number of selections may be 4 in a 12-pick event set. Then, there are 9 possible pools in a 12-pick event set (e.g., one pool for each of 4, 5, 6, 7, 8, 9, 10, 11 and 12 correct picks. In an illustrative example, the total bet may be $9.00 for betting on all possible pools or variations in betting may be permitted such as $2.00 for a bet with five picks (which would include four or five correct picks). For $1.00, the bettor may get a chance to win a single pool anywhere from a 4 pick to twelve 12 pick. Multiple winners may be split according to a formula or by simply splitting the won pool.

Other potential pools may include any number of possible picks (e.g., 10, 14 or other number of possible correct picks). Each game may have additional pools for lower numbers of picks as well. These smaller pools may include a portion of the money from the largest possible number of correct picks pool.

To encourage betting on the higher number pools, when a pool is hit, it may award the accumulated money in that number pool, and any un-hit pools of lower numbers. Consecutively designated races may carry over amount in same number pools from race to race, and from day to day, throughout the year. To permit all players the opportunity to enter their wagers on any or all offerings, designated races may be scheduled not less than 10 minutes apart. This amount of time may be adjusted according to the circumstances.

In block 15, the betting slips or mark-sense cards of present invention are preferably submitted to an agent or entered over the Internet or other network via an electronic interface, such as for example, a kiosk-like interface or a personal computer. The agent enters the data either manually or automatically by a card reader or similar device. A receipt or ticket may be issued to the player at the time the bet is placed, or an electronic confirmation may be returned to the player over the network. In this way, the player can determine if the selections or picks are correct, and appropriate action may be taken to correct errors.

In block 16, pools based on the amount of betting, and the number of bets, carry over or spill over pools from previous games or any other circumstance may be employed to determine the purse or prizes. In one embodiment, a bet is placed for a given amount of money and the pay-off for given number of correct picks could be rewarded as the amount bet x prize/dollar bet to determine the amount won. In other embodiments, the amount won may be fixed per ticket purchased based on the type of event, the circumstances surrounding the events, odds, or any other criteria.

In some embodiments, un-hit pools may spill over to the next set of races, thereby building potentially large payoffs in the pools. In still other embodiments, winners of a game may divide equally or unequally accumulated money in the pool which they hit, and all un-hit pools of a lesser number. For example, in one scenario, one winner has picked all 12 results and therefore wins the top prize or pool. However, if prizes are not awarded to a bettor who has selected 10 or 11 correct results, and these pools have no winners, the top prize is supplemented by the 10 and 1 1 correct picks prize pools.

The odds of picking the exact order of finish for the highest number pools (e.g., 10, 11 and 12 correct picks) can generate the potential for multimillion-dollar payouts, depending on the number of players.

Determination of the pools and prize scenarios may further include handicapping by studying past performances of event participants, etc. Handicapping can increase the chances to pick a winner, which can make the game of the present invention more attractive to veteran horse players, and it will attract new players to the sport looking to better their chances of winning. Depending on the game, enhancements may be included by adding other races or events to a given game card to increase or decrease a player's score (e.g., number of correct picks). For example, a point may be awarded if a given horse finishes in second place or if a given team wins the third game. Enhancements may be employed to increase revenue for the house. For example, for an extra dollar, an event or outcome may be selected to enhance the overall score or to increase the amount of winnings for that player. For example, if a certain horse places in a predetermined position in, say, the third race, the player wins $50, or the player gets 2 points added to his/her score.

In block 18, a result for a particular game is posted and winners are determined. After a result is posted, the money in each pool may be distributed to winners. In one embodiment, 90% of the money in each number pool hit is divided among winners as in pari-mutuel betting. The 10% remaining in the pool will carry over to the next consecutive set of races, for example, to seed the pool of the same number of picks.

If no winner is declared for a particular number(s) of picks, the total money held would drop into the next set of consecutive races of an equal number. Un-hit pools may carry on indefinitely, and may be added to the same number pools in the next set of races offering at least the number of entries permitted by rule. The longer a pool is un-hit, the higher the eventual payout. Un-hit pools for second, third, etc., place prizes (or consolation pools) are preferably rolled up into the “highest number” pool, if there is no declared winner for the consolation pools.

Un-hit pools may be employed by the house to make up for minus pools. Minus pools exist where the number of winners in a particular pool reduces the payout below one dollar ($1.00). In accordance with the invention, the next higher pool or pools may be employed to make up the difference. Minimums could be set for any pool equal to or in excess of one dollar.

Where there is a minus pool, money or points to augment the deficit pool or pools may come from a next higher pool. Minimum payouts may be set for the lower number pools, for example, one dollar for a four pick pool, and five dollars for the five pick pool.

Limits may be set on the maximum amount of money to be held in any pool. An un-hit pool exceeding such a limit would spill its excess money into the next lower numbered pool—after the results of a race putting a pool over the limit are posted. Winners of previous races should not affect advanced betting pools.

The present invention has the potential to draw the attention of the media, bringing new fans to racing or other sporting or random events, which will be attracted to high payoffs on par with state lotteries. Although the present invention is illustratively described for 12 horse positions in three races, the method of the present invention can be practiced in many variations. For example, the methods of the present invention may be offered in other race configurations for one, two, three, four, six, or twelve races. Other configurations and variations are also contemplated.

For in-person, real-time betting transactions, errors may occur in placing bets. Scratched entries and errors should be investigated upon turning in the betting slips or mark-sense cards. Confirmation slips or receipts may be issued.

Scratched entries preferably will not cause a refund. The scratched entry may simply drop the bettor's wager to the next lower number of picks included in its pari-mutuel pool.

To fairly equalize the odds for bettors playing different race offerings, by rule, a race may have a minimum number of entries when designated, and a limited number of scratched entries at post time. A race that drops below the limited number of entries will be considered as all entries scratched. No refunds will normally be made unless the bettor's picks drop below four.

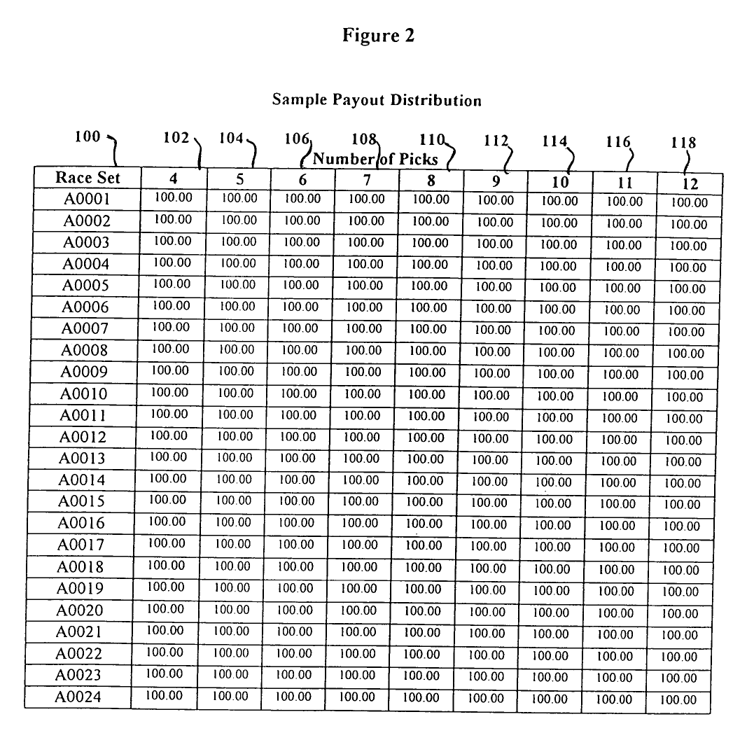

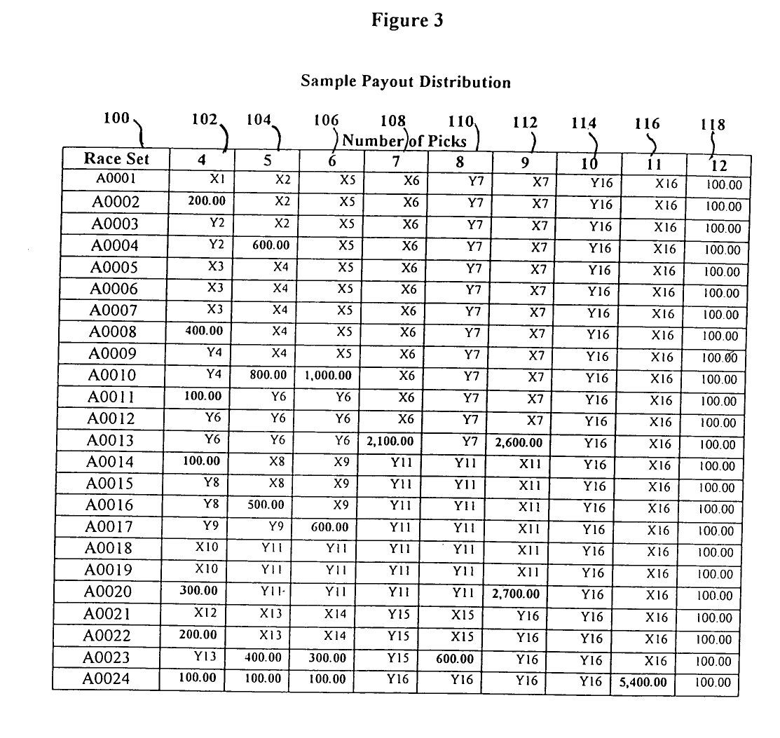

In a preferred embodiment, winners are determined by adding the number of correct picks that the player accumulated. Payouts are preferably based on the start race in which the bettor began to make his or her selections and the number of correct selections. A payout matrix (see e.g., FIGS. 2 and 3) can be generated and maintained by the sponsoring agent in block 20. This matrix may then be employed to determine the winnings based on start race, number of correct selections or picks and any carry over pools if applicable. In block 22, payouts are given to winning players upon submission of a receipt, playing card/slip or electronically, e.g., via Internet.

Sponsoring Agency:

A sponsoring agency may have sole ownership and complete authority in sanctioning betting organizations, and in the administration of all designated races. It is preferable that all transactions be reported to and recorded by the sponsoring agency. In this way, pools are determined and maintained, odds calculated and payouts are defined based on all the data collected. Betting organizations may include thoroughbred racetracks, off-track betting parlors, casinos or any other organization sanctioned by the sponsoring agency. Each betting organization may report to the sponsoring agency or may run games independently of the sponsoring agency, but under the agency's supervision. It is preferable that all participating betting organizations share in joint pools administered by the sponsoring agency. In this way, payouts may be larger and preferably rival state lotteries. In addition, designated races or betting opportunities are offered only in races at racetracks or venues approved by the sponsoring agency. It is noted that the game may be played independently by individuals or be carried out by organizations, in accordance with the present invention. To encourage fan participation, the sponsoring agency may guarantee minimum payouts in the higher number pools. The probability of randomly picking the exact order of finish for a 12 pick is very small, but significantly increased however, if bettors apply even minimal handicapping skill to their selections. The sponsoring and betting organizations should make every effort to give bettors every opportunity to become educated in handicapping.

The sponsoring agency or approved organizations can offer, for free or purchase, instruction in techniques of handicapping as a means of assisting the bettor in interpreting published statistics on entries. The means of such instruction can be through videos, pamphlets, tout sheets, seminar and classes, in person, or via the Internet, or any other means.

The sponsoring agency may be tasked with ensuring that racetracks and/or sporting or other events are sanctioned in their program and should have suitable and approved resources to be able to determine the exact order of finish within a reasonable degree of certainty.

Accumulated interest on pool money held on deposit may be used by the sponsoring agency to support its operations and for the promotion of its games.

The sponsoring agency preferably maintains books and records for game transactions, and provides and maintains a database, preferably a computer database which is employed in administering the game of the present invention. The game may be run over a network, such as the Internet, or performed manually in a betting parlor or other facility. The sponsoring agency will be responsible for establishing take-out for all participating organizations.

Automated Bet Offerings:

For automated betting embodiments, additional games or games features may be employed, some examples follow.

Insurance: Computer implementation of bet data gathering may increase winning opportunities for a bettor's wager by including all lesser pools for a specified pick. For example, if a wager is placed on a pool for getting all 12 results correct, for an additional amount the bettor may include themselves in lesser pools, for example the 8 correct picks pool, the 9 correct picks pool, the 10 correct picks pool, and/or the 11 correct picks pool. Other pools may or may not be included.

Pick & Mix: The computer may select from a portion of the top favorite picks, for example, six of the top favorite horses in each race, as can be best determined by the morning line, and the computer can randomly sort the order of finish in each race to make up the bettor's picks.

Wild Pick: The computer may randomly select entries from the entire field in each race to complete the bettor's picks.

Referring to FIGS. 2 and 3, advanced betting on a single betting card (see e.g., FIG. 4) will be permitted, using the same picks in as many consecutive races as desirable. In the illustrative example, shown in FIGS. 2 and 3, picks may be made in many sets of races. Race sets are listed from A0001-A0024 in column 100. Nine different pick games are shown in each of columns 102-118. To simplify this illustration, all pools for each race include an equal number of bets totaling $100.00 after takeout. The race column 100 indicates a starting race where the betting began.

After the results of a set of events, such as races, the numbers indicated in FIG. 3 represent an amount paid for a hit pool (i.e., a win). Amounts paid may actually be less of accumulated pools if the sponsoring agency takes a portion of the winnings, etc. In this example, the amounts of the winning pools include the amounts not won from all the pools above (same number of correct picks) and all un-hit lower number pools to the left (same start race, but fewer correct picks). The pools above are marked as “X” and the pools to the left are marked “Y”. The winning amount of a given box position is determined in this example by adding all of the X's and Y's of the same number in FIG. 3 plus the amount of the pool at that given box location. This means for example, all available pools above and to the left of a given box are part of a prize if there are no other winners above or to the left. This method of payout may be a called a “cumulative” payout. In other embodiments, only the actual pool corresponding to the start race and the numbers of correct picks may be employed.

For example, if after 12 races, a player's start race was A0004, and that player has 5 out of 12 picks correct; then, that player wins $600. The $600 is the result of adding the three $100 pools above the race A0004 position, 5 picks correct position (X2's) and adding to that the Y2's (to the left and above) and adding to that the amount of the A0004 race, 5 correct pick position (in this case $100). This results in a $600 payout. If more than one winner exists for the box (race A0004 and 5 correct picks), the pool is split between the number of winners. If there are other winners in the vicinity, this deducts the winnings from prizes further to the right or below the winning position. In this illustration, the 12 correct pick (column 118) pool carries over to race A0025 (not shown) since there were no winners. Likewise remaining entry pools in other areas of the chart, which are not collected, would carry over to future races. It is to be understood that other combinations and scenarios may be employed in accordance with the present invention.

Referring to FIG. 4, an illustrative betting card 200 is shown in accordance with one embodiment of the present invention. Card 200 indicates a betting slip for a three-race bet with up to 9 picks available. Card 200 may include a starting race indicator portion 202 which can be manually filled-in or filled in by computer. Alternately, the card may include an identifier number or be assigned one upon issuance. In region 204, the player indicates a number of picks that they chose to make. In this embodiment, a minimum of four picks is required. A check-off box 206 may be employed to indicate a number of picks, in this case 12 are indicated. A race or event number is indicated in region 208 as well as the place or position of the result (e.g., win, place, show, fourth, etc.). In an entry section 210, the horse number or other indicia is selected by the player or by the agent (e.g., by computer). The card is filled-in for the number of selections indicated, in this version 12. In this case, all 12 selections are made (indicated by shaded or darkened boxes in region 210.

In region 212, an amount of wager is indicated. The amount may include any amount; however, denominations of between $1 to $10 are shown and may be selected. Other amounts are also contemplated. Additional games may also be indicated on card 200. In the embodiment shown, indicator regions 214, 216 and 218 are included for an insurance game, Pick & Mix game and Wild Pick game, respectively. With the insurance game option, a wager will be increased to include all lesser pick pools. An additional wager may be applicable. For Pick & Mix, entries are selected from favorites (e.g., favorite horses) at time of wager and randomly sorts order of finish for each race. Wild Pick randomly selects entries to complete the wager card. Other regions 220 may also be included to provide additional gaming options.

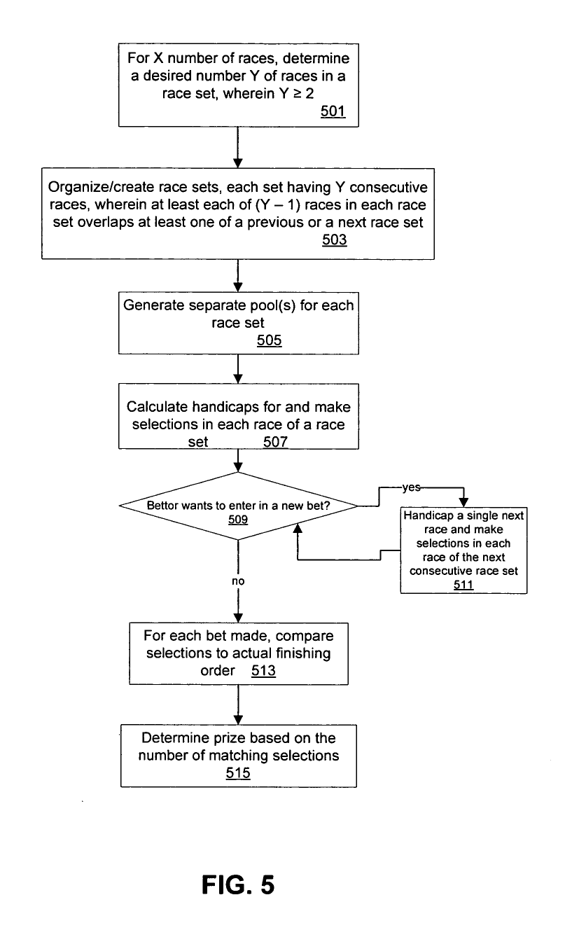

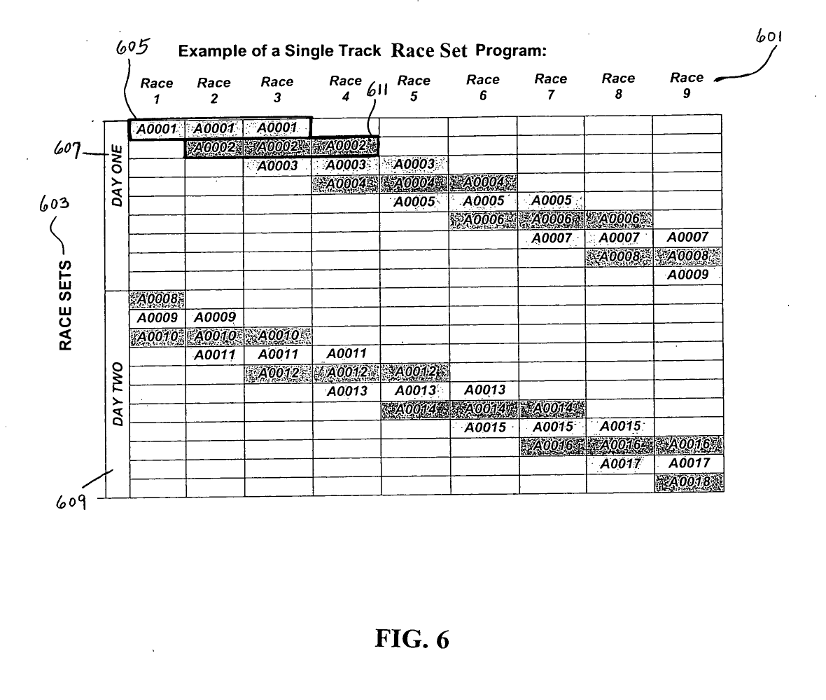

FIG. 5 depicts a flow diagram illustrating an exemplary gaming method according to an aspect of the present invention. For a given X number of consecutive events/races, a subset of Y consecutive events/races is determined to comprise a race or event set (step 501). The variable X may comprise any numerical value, and the value Y may be any numerical value preferably greater than or equal to 2. Further, X and Y may bear a direct numerical relationship with each other (e.g., the number value of Y may be a factor of X). For example, where X=9 races and Y=3, each race set comprises 3 consecutive races. (See e.g., FIG. 6).

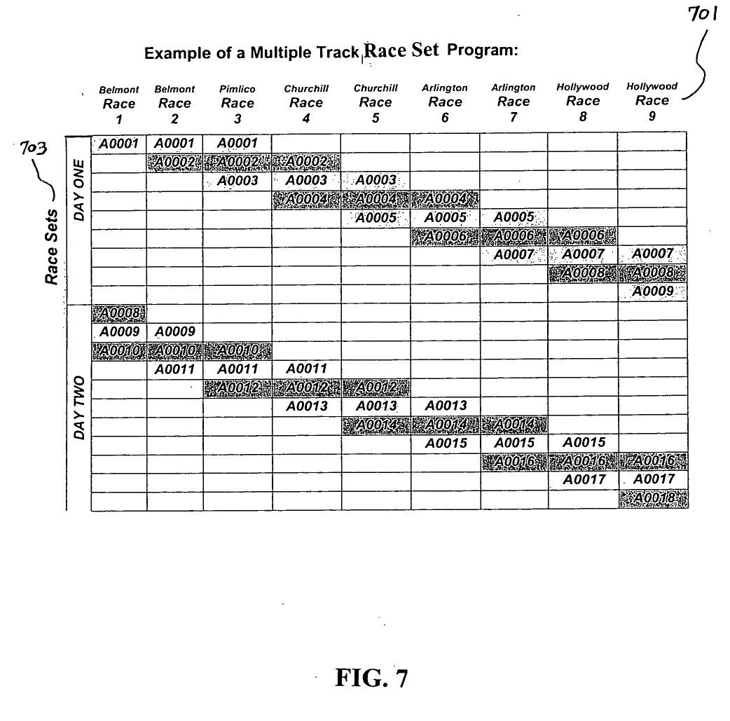

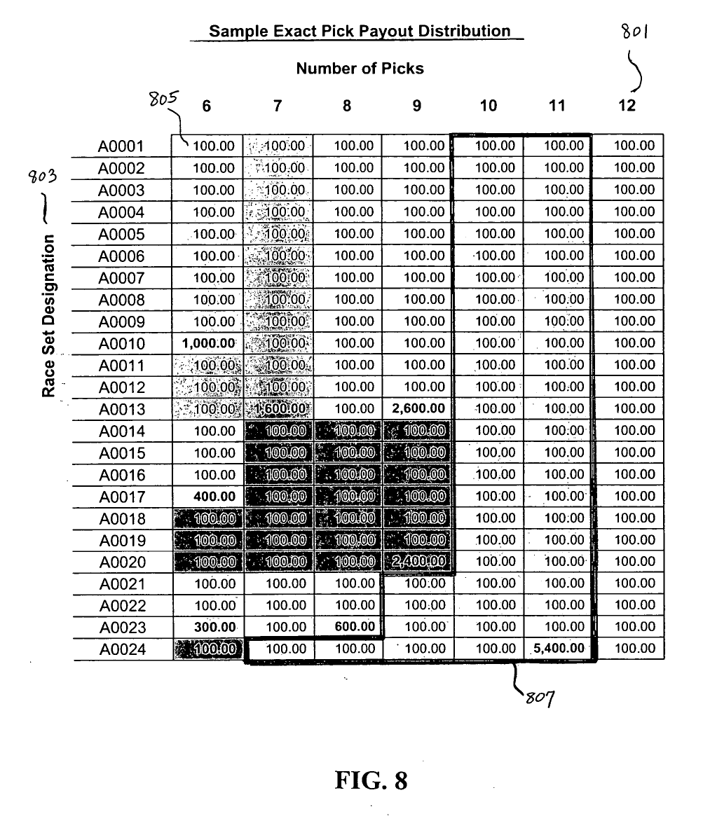

In step 503, a plurality of overlapping race/event sets is created, each race set comprised of Y consecutive races. At least each of (Y−1) races in each race set overlaps at least one of a previous race set or a next race set (explained further below with reference to FIGS. 6-7). Separate betting pool(s) are generated for each race set (step 505), thus each race set comprises a separate bet. Exemplary betting pool(s) may comprise a pool for each number of correct picks (e.g., see FIG. 8), and/or an all correct-picks pool.

A bettor/player calculates handicaps for and makes selections in each race of at least one race set (step 507), and upon doing so, is entered into a single bet. Selections in a race may comprise, e.g., picks for Win, Place, Show, fourth, etc., or any one of these or combination thereof. In decision box 509, it is ascertained whether the bettor desires to enter into a new bet. If yes, the bettor need only handicap a single additional race (i.e., the next consecutive race, which is also the last race in a following race set), and make selections in each race of the next consecutive race set (step 511) to be entered into a new bet. Advantageously, a system and method according to the present invention enables bettors to enter into new bets by simply handicapping one additional event/race. This maximizes the number of bets for a given number of races while minimizing the effort required on the part of the bettor/player, thus generating fast-paced excitement and increasing interest and player participation.

The bettor may enter into as many new bets as desired (return to step 509). If the bettor does not wish to enter into a new bet, the method proceeds to step 513 in which following the occurrence of each race/event, for each bet made, the bettor's selections are compared with actual finishing order(s). A prize, if any, is accordingly determined based on the number of matching selections (step 515).

To illustrate, for the example given above where X=9 and Y=3, FIG. 6 depicts an exemplary overlapping race set program at a single track according to an aspect of the present invention. For X number of events/races 601 (here e.g., X=nine races) a plurality of race sets 603 are created each comprised of three races each (Y=3). For example, race set 605 is a first race set (designated as race set A0001) comprised of races 1, 2, 3; and race set 611 is a second race set (designated as race set A0002) comprised of races 2, 3, 4. Each race set 603 (A0001, A0002, etc.) comprises a separate bet. In this exemplary program, nine races are run on each of day one 607, and day two 609. Accordingly, nine races may comprise nine separate bets on each day, with the bets of the last two races (Races 8 and 9) carrying over to the next day.

Note that in this example (where Y=3), the second race in each race set comprises the first race of the following race set. After the first two races of such a program, every race both begins and ends a race set (and accordingly, a bet). It is noted that since Y may comprise any number, if Y=4, than the overlapping race set configuration would comprise races 1-2-3-4; 2-3-4-5; 3-4-5-6 etc. In each race set, at least (Y−1) races overlap at least one of a previous or a next race set. That is, e.g., where Y=3, at least (3−1) or 2 races overlap at least one of a previous or next race set. To illustrate, in FIG. 6, for race set A0001, races 2 and 3 overlap a next race set A0002 and A0003. In race set A0003, races 3, 4 and 5 overlap previous (A0001, A0002) and next (A0004, A0005) race sets.

Preferably, each race set is timed and arranged to overlap in sequence to help generate fast-paced excitement. This ‘cascading’ effect according to one aspect of the present invention enables bets and betting to continue on indefinitely, with bets/race sets carrying over into a following day of races, and so on. Advantageously, bettors are tied into races and race events continuously over periods of days, weeks, etc., thus ensuring and maintaining long-term, continuous and consistent bettor interest and participation.

FIG. 7 depicts an exemplary multiple track race set program according to an aspect of the present invention. For example, a race set program may be comprised of events/races 701 which take place at different locations (e.g., various racetracks across the country or abroad) within a same day or multiple days/weeks. Preferably, the races/events occur consecutively and thus are arranged in order of occurrence.

FIG. 8 depicts an exemplary Exact Pick payout distribution according to an aspect of the present invention. In this example, each event/race includes at least 12 entries/participants, and for the sake of simplicity, all pools 805 for each race have an equal number of bets totaling $100.00 after takeout. Here, separate pools are generated for each number of correct picks 801 ranging from 6 correct picks to 12 correct picks. Each race set 803 preferably comprises a plurality of races in consecutive order (as described above). Upon completion of the events in each race set 803 (A0001, A0002, etc.) bettors with a number of correct selections which match a number of correct picks pool 801 will ‘hit’ or collect on, that pool. Such a winning pool includes all the bets above and all un-hit lower number pools to the left. As race events/sets continue to occur with no winning bettors (and thus no ‘hit’ pools), the pools will accumulate into larger amounts.

For example, in race set A0024, there is a winner with 11 correct picks. The total payout for this winning pool would include all pools 805 in the 11 picks column, as well as all un-hit lower number of correct pick pools (here, from 7 correct picks pool to 10 correct picks pool). Accordingly, the total payout to the winner here would be $5400.00.

In another example, in race set A0013, the 9 correct picks pool was hit, with a $2600.00 total payout. This payout amount was calculated as follows: here, the winning pool included all the bets in the 8 and 9 correct picks column from A0001-A0013. Note that since the 7 correct picks pool was also hit in race set A0013 (for a payout of $1600.00), none of the pools from the 7 correct picks column and below are included in the payout for the 9 correct picks in race set A0013.

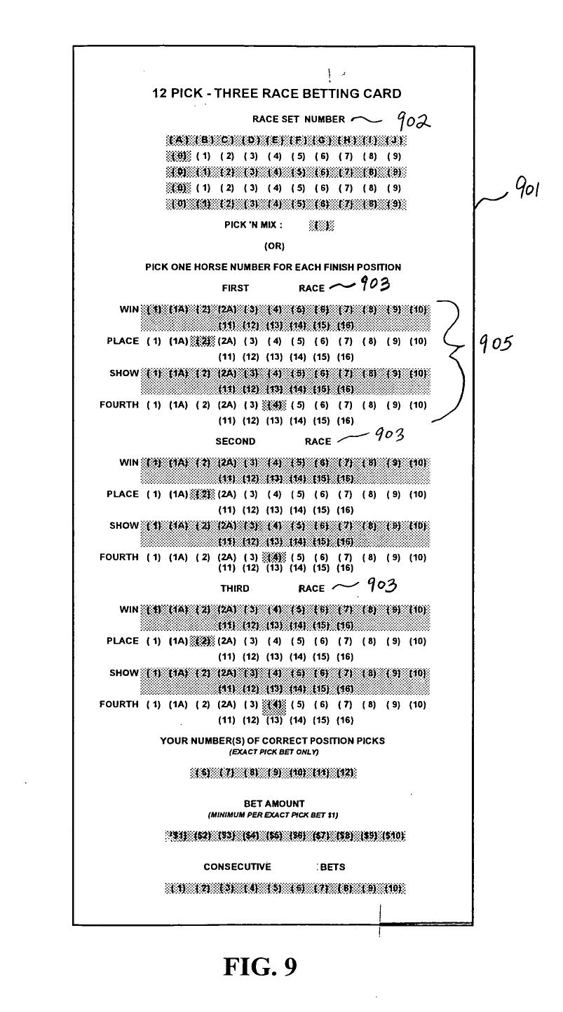

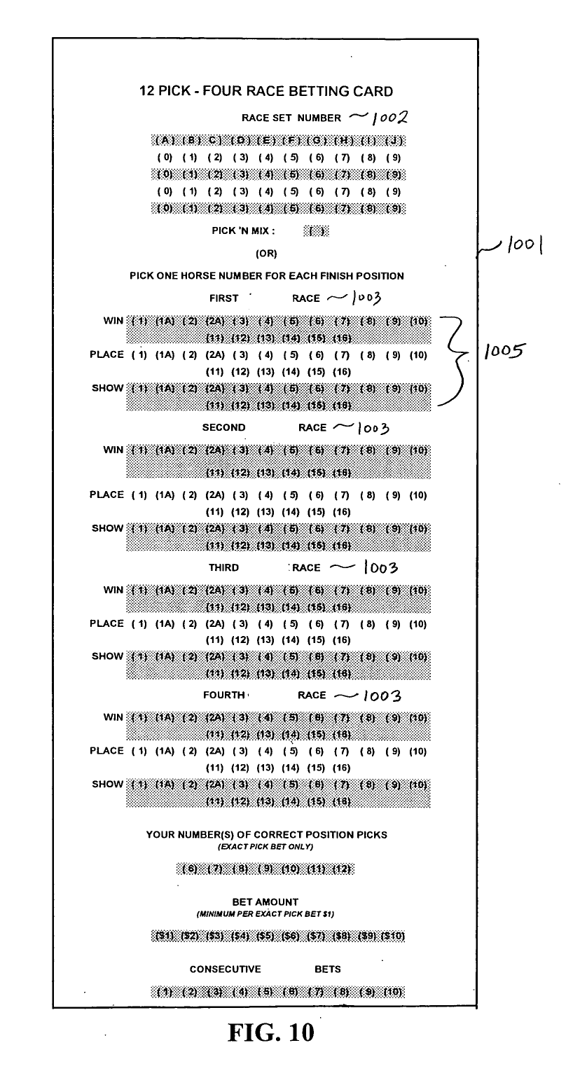

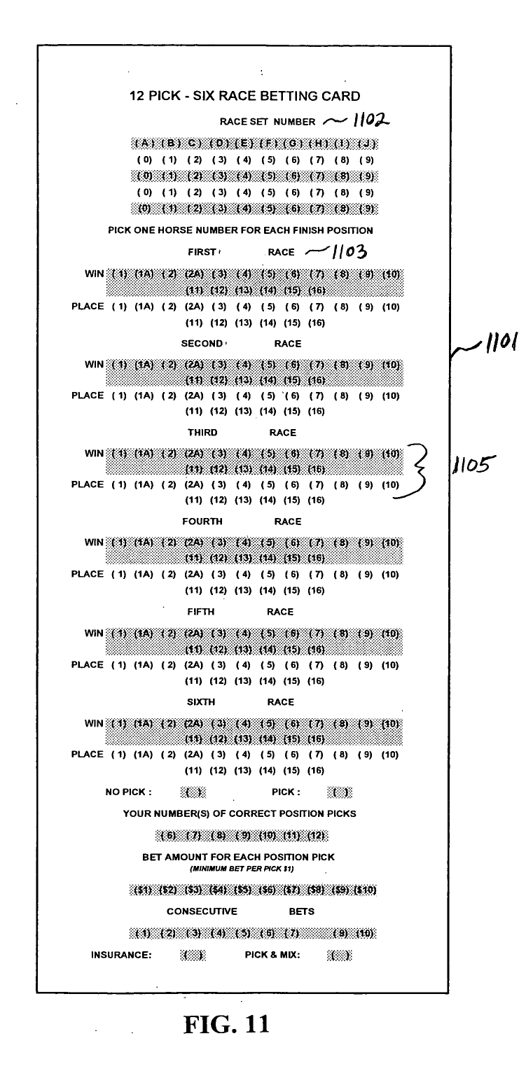

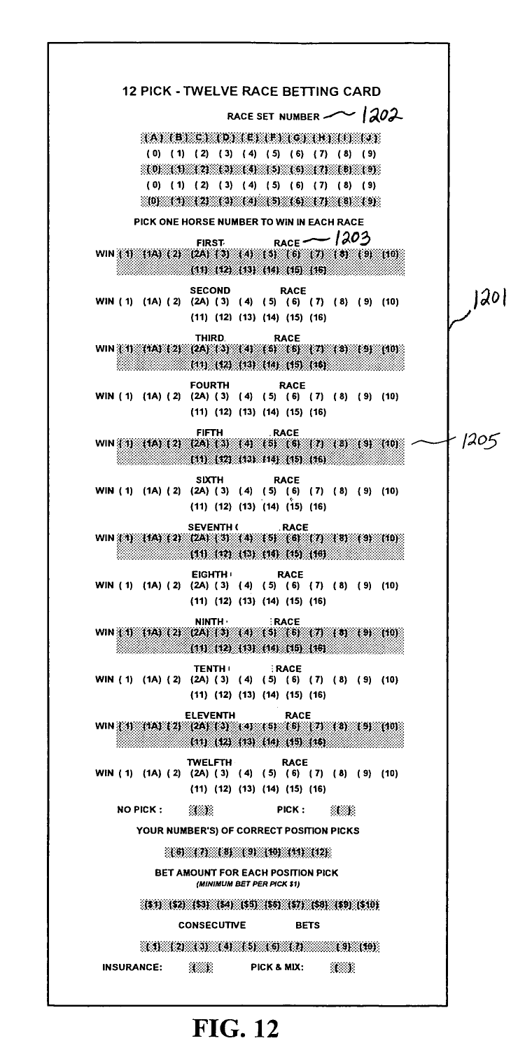

FIGS. 9-12 illustrate various exemplary betting card layouts for a 12 pick bet according to exemplary aspects of the present invention. Each betting card 901, 1001, 1101, 1201 comprises a separate bet for a particular race set 902, 1002, 1102, 1202. A player makes selections for various finish positions 905, 1005, 1105, 1205. The number of finish positions may vary according to the number of races in each race set. For example, for a 12 pick three race betting card 901 (where each race set is comprised of 3 races 903), the player may make selections for Win, Place, Show and Fourth 905. For a 12 pick six race betting card 1101 (each race set being comprised of six races), the player may make selections for Win and Place positions 1105.

### EXAMPLES

Betting programs may be offered in any number of race configurations, for example from one, two, three, four, six, nine or twelve races. Preferably, a race set includes at least two consecutive races.

Examples of Selection Offerings:
Nine Pick: Win, Place, and Show in three races.
Twelve Pick: Win, Place, Show, and Fourth in three races, or Win, Place, and Show in four races.

Wagering and Pools:
The recommended bet size is one dollar for each race set pick permutation.
Though betting can be made through a cashier window or telephone, bets preferably should made through automated teller machines or via the Internet where legal.

In one exemplary version of there would be two pools: one for winners correctly hitting all picks, and a second lesser pool for payouts to the highest number of correctly hit picks for each race set. To illustrate:

[symbol]

12 Pick Three Race Bet (see e.g., FIG. 9)
Winning picks are highlighted in gray below:

| | | | |
|---|---|---|---|
| ∘ Bet Selections: | 1.2.3.4 | 1.2.3.4 | 1.2.3.4 |
| ∘ Finish Results: | 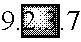 | 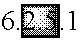 | 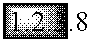 |

| | |
|---|---|
| ∘ Winner: | Six Correct - Highest Number Picked Pool |

In another exemplary version, a bet would be divided into separate pools for each number of picks offered in the program (i.e., ‘specified number of picks’ pools), 6-12 picks for example. The winning bet would be paid from the pool representing a bettor's highest number of correct picks (See, e.g., FIG. 8).

[symbol]

12 Pick Three Race Bet
Winning picks are highlighted in gray:

| | | | |
|---|---|---|---|
| ∘ Bet Selections: | 1.2.3.4 | 1.2.3.4 | 1.2.3.4 |
| ∘ Finish Results: | 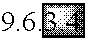 | 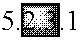 | 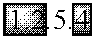 |

| | |
|---|---|
| ∘ Winner: | Seven Correct Picks Pool |

Any hit pool may pay at least one dollar or more after takeout to qualify for a payout or minus pools may be funded by cascading money from higher pools.

Consecutively designated races carry over same number pools from race to race, and from day to day, throughout the year.

Un-hit pools spill to the next race set. If no winner is declared for a particular number(s) of picks, the total money held would drop into an equal pick number pool in the next race set, thereby building potentially large payouts in the higher number pools.

Multiple winners of a bet divide accumulated money in the numbered pool they hit.

A hit pool includes any un-hit lesser pools (see FIG. 8).

To allow all players in, e.g., the United States the opportunity to enter their wagers on any or all bet offerings, designated races should preferably be scheduled between noon and midnight (Eastern Standard Time), and scheduled not less than 10 minutes apart.

After a winning result is posted, 90% of the money in the all-picks-correct-pool hit is to be divided among winners as in pari-mutuel betting. The 10% remaining in the pool will carry over to the next consecutive set of races to seed the next all-picks-correct-pool. This may also be done for all pools in the second version (certain number of correct picks).

Un-hit pools will carry on indefinitely, added to the same number pools in the next set of races offering at least the number of entries permitted by rule. The longer a pool is un-hit, the higher the eventual payout. However, limits may be set on the maximum amount of money to be held in any pool. An un-hit pool exceeding such a limit may spill its excess money into the next lower pool—after the results of a race putting a pool over the limit are posted.

Additional rules may include:
Payouts will not affect advanced betting pools.
Takeout is on wagers rather than winnings. No takeout will be permitted on cancelled wagers.
The betting system shall comply with the rules and laws within each state or country it is offered. If such rules or laws should put its participants at a disadvantage to the majority of bettors, it shall not be offered in that state or country.

Scratches and Fields:
To fairly equalize the odds for bettors playing different race offerings, by rule, a race, and/or race set, should preferably have a minimum number of entries when designated, and a limited number of scratched entries at post time.
Scratched entries will not usually cause a refund. Immediately after a scratch, the computer will advance the remaining picks the bettor has included in his bet for the race in which the scratch occurs, and will then replace the scratch with an unpicked favorite. Another option is a random replacement pick from the remaining field.
Refunds will only be made when the bettor's picks for a race or race set is from a field(s) with less than a predetermined minimum number of entries at post time.
Field and coupled horses must be bet individually.

Sponsoring Agency:
For a betting system according to the present invention to become an inter-track offering it may be subject to the overview of a sponsoring agency, which may be a track, an existing agency, or one formed through the cooperation and partnership of participating betting organizations, and/or a totalizer company.
The sponsoring agency may have complete authority in sanctioning betting organizations, and in the administration of all designated races.
Betting organizations are thoroughbred racetracks, off-track betting corporations, casinos, or any other organization sanctioned by the sponsoring agency.
All participating betting organizations are to share in joint pools administered by the sponsoring agency.
Designated races are betting opportunities to be offered only in races at thoroughbred horseracing tracks approved by the sponsoring agency (though a betting method according to the present invention could be adapted to other types of racing, or sports).
To further encourage player participation, the sponsoring agency may solely, or in cooperation with its partners, and/or third party advertisers, guarantee minimum payouts in the higher number pools. Considering the odds of such payouts and the 10% carryover, risk to insurers would be minimal.
Inter-track pool money carried over may be deposited into a common escrow account administered and monitored by the sponsoring agency. The sponsoring agency and the appropriate banking and governmental authorities would enforce rules for account administration.
The probability on randomly picking the exact order of finish for a 12 Pick may be very small, but is significantly increased however, if bettors apply even minimal handicapping skill to their selections. The sponsoring agency and its betting organizations should make every effort to give bettors every opportunity to become educated in handicapping.
The sponsoring agency may insure that racetracks including sanctioned races in their program have approved resources to determine the exact order of finish within a reasonable degree of certainty.
Accumulated interest on pool money held on deposit can be used by the sponsoring agency to support its operations, or for the promotion of thoroughbred horse racing.
The sponsoring agency may collect fees and royalties from all participating tracks and betting organizations for itself and for payout to the inventor, the details of which would be subject to negotiations.

Automated Bet Offerings:
‘Pick 'N Mix’: A computer system may select from six of the top favorite horses in each race at the time of the bet, as can be best determined by the morning line and/or actual betting, and then randomly sort the order of finish in each race to make up or complete the bettor's picks.
Advanced betting on a single betting card may be permitted, using the same number of picks and selections in as many as ten consecutive race sets (see sample betting slips of FIGS. 9-12).
To prevent syndicates from hijacking large pools through computerized boxed betting, boxed bets should be limited or completely excluded.

Marketing:
The odds of picking the exact order of finish for the highest number pools are such that they will generate the potential for multimillion-dollar payouts. Handicapping greatly increases the chances to win, which will make a betting method according to the present invention attractive to veteran horseplayers looking to hit the large payouts.
A betting method according to the present principles can attract new players to the sport who are looking to better their chances of winning over lotteries. Though lotteries may pay out on a lesser number of number picks, the results are random, so the best the bettor can depend on is pure chance to hit a jackpot. However, in a betting method according to one aspect of the present invention, the numbers become weighted through handicapping. These numbers represent something tangible, thoroughbred racehorses and jockeys with a performance records, competing in arguably the most exciting sport in the world.
A betting method according to the present principles has the potential to draw the attention of the media, bringing new fans to thoroughbred horseracing who are otherwise presently attracted to the high payouts of lotteries.
As a means of tying together a single day's racing for events, e.g., like the Breeder's Cup or Triple Crown events, all qualifying races could be offered in a betting program according to an aspect of the present invention. The bettor with the highest number of winners for the day would cash out the remaining un-hit pools. Seeding or guaranteeing the all-pick pool would have the potential of increasing interest in the program and thereby increase handle on all sets of races offered for the day.
A betting method according to the present principles could be offered as an Instant Betting option on linked machines. The machines could offer an escalating bet, where the bettor increases his bet amount by the number correct picks pool bet (one dollar for the minimum six picks correct pool, and an additional quarter for each higher pool pick up to twelve correct picks—see FIG. 8 for sample payouts). Seeding jackpots for the higher number picks would heighten bettor interest in the Instant Betting machines.
It may be feasible to look into establishing special partnership agreements, where a betting method according to the present invention could be offered through state lottery machines already equipped to handle this type of betting format, which would greatly increase racing's market outlets.
Participating organizations, or third party advertisers looking to gain exposure can tie their name to the bet by sharing marketing expenses and guaranteeing that All Correct Picks jackpots pay a significant minimum:

Having described preferred embodiments for a gaming method (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A gaming method comprising the steps of:
determining for X number of consecutive events, a subset of Y consecutive events comprising an event set;
preparing from said X number of consecutive events a series of overlapping consecutive event sets, each event set having Y consecutive races, wherein at least each of (Y−1) events in each event set overlaps at least one of a previous event set or a next event set; and
generating at least one separate betting pool for each event set.

2. The method of claim 1, wherein Y≧2.

3. The method of claim 1, further comprising the steps of:
calculating handicaps for each race of a first race set;
making selections to predict a finishing order in each race of said first race set, wherein if a new bet is desired to be entered, further comprising the steps of:
calculating handicaps for a single next race; and
making selections to predict a finishing order in each race of a second race set.

4. The method of claim 3, wherein the single next race comprises the last race of the second race set.

5. The method of claim 3, further comprising the steps of:
comparing the selections to actual finishing orders; and
determining a prize based on a number of matching selections.

6. The method of claim 5, wherein the step of determining a prize further comprises:
providing a correct number of picks pool for each of a specified number of correct picks; and
awarding a winning correct pick pool corresponding to a player with a matching number of correct picks, wherein said winning correct pick pool comprises all pools with the same winning number of correct picks in preceding events and all un-hit lower number pools.

7. The method of claim 1, wherein the step of generating further comprises generating at least one of an all-correct picks pool, a specified-number of picks pool and a highest number of correct picks pool for each race set.

8. A gaming method comprising the steps of:
calculating handicaps for each race of a first race set and making selections to predict the finishing order in each race of the first set of races in a first bet; and
making selections to predict a finishing order in each race of a second race set and calculating handicaps for a next consecutive race following the last race of the first race set to enter into a second bet, wherein the next consecutive race comprises a last race of a second race set.

9. The method of claim 8, wherein each race set comprises a set of three consecutive races.

10. The method of claim 8, wherein each of the first and second race sets overlap such that the first race of the second race set is the second race of the first race set.

11. The method of claim 8, further comprising the step of generating at least one pool for each race set.

12. The method of claim 11, wherein the at least one pool comprises at least one of an all-correct picks pool, a specified-number of picks pool and a highest number of correct picks pool for each race set.

13. The method of claim 11, further comprising the steps of:
comparing selections to actual finishing orders; and
determining a prize based on a number of matching selections.

14. The method of claim 13, wherein the step of determining a prize based upon a number of matching selections in each bet includes determining the prize based on carry over from un-hit pools of previous bets.

15. The method of claim 14, wherein the previous bets include un-hit pools created for races with a lower number of correct picks and/or un-hit pools from races having the same number of correct picks.

16. A gaming method comprising the steps of:
providing a first game card for listing a first set of three consecutive races and a plurality of entries for each race;
providing a second game card for listing a second set of three consecutive races and a plurality of entries for each race, wherein a first race of the second set of races comprises the second race of the first set of races;
handicapping each race on the first game card and indicating on the first game card a speculated order of finish for up to four entries in each race of the first set of races in a first bet;
handicapping a next race following the last race of the first set and indicating on the second game card a speculated order of finish for up to four entries in each race of the second set of races in a second bet;
generating at least one pool for each of said first and second bets;
comparing the speculated order of finish with a determined finishing order of each race to determine a number of matching entries within each bet; and
determining a prize based upon the number of matching entries.

17. The method of claim 16, wherein the at least one pool comprises at least one of an all-correct picks pool, a specified-number of picks pool and a highest number of correct picks pool for each race set.
